(19) United States
(12) Patent Application Publication
(10) Pub. No.: US 2011/0182187 A1
(43) Pub. Date: Jul. 28, 2011

(54) WIRELESS COMMUNICATION SYSTEM AND METHOD FOR PERFORMING COOPERATIVE DIVERSITY USING CYCLIC DELAY

(75) Inventors: Byung Jang Jeong, Daejeon (KR); Taegyun Noh, Daejeon (KR); Hyun Kyu Chung, Daejeon (KR); Jae Hong Lee, Seoul (KR); Dong Woo Lee, Seoul (KR)

(73) Assignees: Electronics and Telecommunications Research Institute, Daejeon (KR); Seoul National University Industry Foundation, Seoul (KR)

(21) Appl. No.: 12/808,909

(22) PCT Filed: Sep. 17, 2008
(86) PCT No.: PCT/KR08/05472

§ 371 Date: Jun. 17, 2010

(30) Foreign Application Priority Data
Dec. 17, 2007 (KR) 10-2007-0132109

(51) Int. Cl. H04L 12/26

(52) U.S. Cl. 370/242

(57) ABSTRACT

A wireless communication system and method of performing cooperative diversity using cyclic delay is provided. A transmitting terminal constituting the wireless communication system includes: a data transmitter configured to transmit data to each of at least one relay terminal and a receiving terminal; an error detection result receiver to receive an error detection result from a relay terminal that detects an error in the data among the at least one relay terminal; and a data retransmitter configured to retransmit data to the receiving terminal when it is determined each of the at least one relay terminal detects the error in the data based on the error detection result.

### TECHNICAL FIELD

The present invention relates to a wireless communication system, and more particularly, to a wireless communication system and method of performing cooperative diversity using cyclic delay.

This work was supported by the IT R&D program of MIC/IITA. [2006-S-001-02, A method for cooperative coding using cyclic delay for multiuser OFDM system]

### BACKGROUND ART

In comparison to existing mobile communication systems, a 4th generation (4G) mobile communication system may need a relatively high speed and a large capacity of data transmission. For the high speed and the large capacity of data transmission, there is a need for a reliability improvement scheme to mitigate performance deterioration caused by multi-user interference and fading that occurs in a wireless channel.

In order to overcome the performance deterioration by fading in a wireless communication channel, researches are actively conducted regarding a spatial diversity scheme using Multiple-Input Multiple-Output (MIMO) technology. However, the spatial diversity scheme using the MIMO technology may have some limits on increasing a number of antennas due to a size limit of a mobile terminal. Also, there is a need for research regarding transmitting and receiving technology of high frequency efficiency for the large capacity of data transmission in the limited bandwidth.

As described above, a cooperative diversity scheme is technology that can achieve fewer transmission errors and maximize the frequency efficiency in the 4G mobile communication system. The cooperative diversity scheme may be new transmission technology that enables users with a single antenna in a wireless network to share an antenna of another terminal and cooperate with each other regarding transmission and thereby enables all the users to achieve the frequency efficiency and the reliability improvement.

Due to a significant increase of uplink traffic such as User Created Contents (UCC), video communication, and the like, the uplink requires a high data rate and reliability. Therefore, the cooperative diversity technology is in the spotlight as key technology of the 4G mobile communication system.

However, in the wireless communication system, research associated with the cooperative diversity technology is insufficient. Also, when a plurality of relay terminals is cooperative, the diversity gain may increase. However, research regarding protocol design related thereto is not greatly advanced.

### DISCLOSURE OF INVENTION

### Technical Problem

An aspect of the present invention provides a wireless communication system and method in which terminals can perform cooperative diversity using cyclic delay in a wireless communication network.

Another aspect of the present invention also provides a cooperative diversity method that can provide improved diversity gain according to a cooperative relay terminal with an improved performance in comparison to an existing wireless communication system.

### Technical Solution

According to an aspect of the present invention, there is provided a transmitting terminal including: a data transmitter configured to transmit data to each of at least one relay terminal and a receiving terminal; an error detection result receiver to receive an error detection result from a relay terminal that detects an error in the data among the at least one relay terminal; and a data retransmitter configured to retransmit data to the receiving terminal when it is determined each of the at least one relay terminal detects the error in the data based on the error detection result.

According to another aspect of the present invention, there is provided a relay terminal including: a data receiver configured to receive data from a transmitting terminal; an error detector configured to detect, via a Cyclic Redundancy Check (CRC), an error in the received data and transmit an error detection result to the transmitting terminal; and a data transmitter configured to transmit, to a receiving terminal, data that is cyclic delayed by a number of transmission symbols of the received data, when no error is detected in the data.

According to still another aspect of the present invention, there is provided a cooperative diversity method including: transmitting data to each of at least one relay terminal and a receiving terminal; and receiving an error detection result from a relay terminal that detects an error in the data among the at least one relay terminal.

In this instance, the cooperative diversity method may further include retransmitting data to the receiving terminal when it is determined each of the at least one relay terminal detects the error in the data based on the error detection result.

According to yet another aspect of the present invention, there is provided a cooperative diversity method including: receiving data from a transmitting terminal; detecting, via a CRC, an error in the received data; and determining whether to cooperate with transmitting of the data depending on whether the error is detected in the data.

In this instance, the cooperative diversity method may further include: transmitting an error detection result to the transmitting terminal, when the error is detected in the data; and transmitting, to the receiving terminal, data that is cyclic delayed by a number of transmission symbols of the received data, when no error is detected in the data.

### BRIEF DESCRIPTION OF THE DRAWINGS

FIG. 1 illustrates an example of transmitting data to a receiving terminal based on cooperative diversity using cyclic delay according to an embodiment of the present invention;

FIG. 2 illustrates an example of transmitting data based on cooperative diversity when each of at least one relay terminal detects an error in the data according to an embodiment of the present invention;

FIG. 3 is a block diagram illustrating a configuration of a transmitting terminal constituting a wireless communication system according to an embodiment of the present invention;

FIG. 4 is a block diagram illustrating a configuration of a relay terminal constituting a wireless communication system according to an embodiment of the present invention;

FIG. 5 is a flowchart illustrating a method of transmitting data based on cooperative diversity using cyclic delay according to an embodiment of the present invention;

FIG. 6 illustrates graphs of a frame error rate and a cooperation probability based on a number of relay terminals constituting a wireless communication system according to an embodiment of the present invention;

FIG. 7 is a graph illustrating a frame error rate of each of when cyclic delay is used and when the cyclic delay is not used in a wireless communication system according to an embodiment of the present invention; and

FIG. 8 is a graph illustrating a frame error rate based on a transmission power allocation of a relay terminal in a wireless communication system according to an embodiment of the present invention.

### MODE FOR THE INVENTION

Reference will now be made in detail to embodiments of the present invention, examples of which are illustrated in the accompanying drawings, wherein like reference numerals refer to the like elements throughout. The embodiments are described below in order to explain the present invention by referring to the figures.

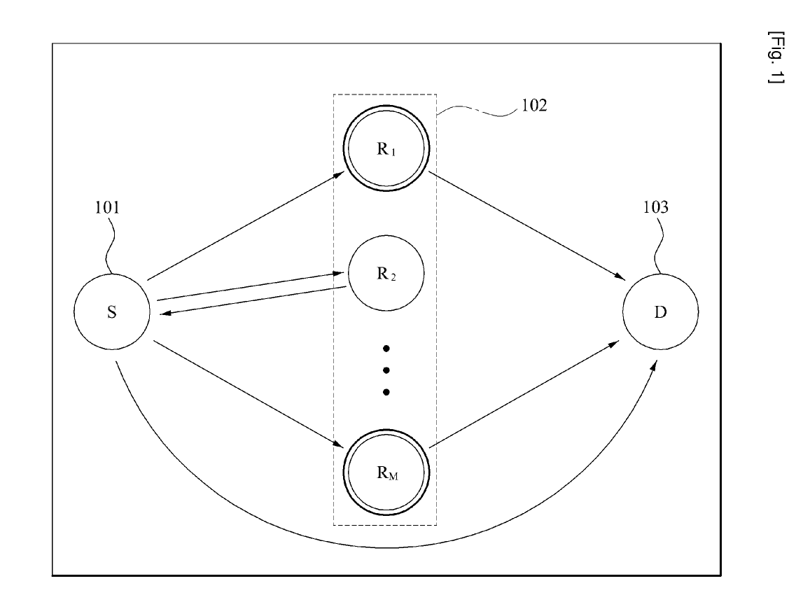

FIG. 1 illustrates an example of transmitting data to a receiving terminal based on cooperative diversity using cyclic delay according to an embodiment of the present invention.

The present invention relates to a wireless communication system for embodying the cooperative diversity using the cyclic delay. For example, the present invention may be applicable to an orthogonal frequency division multiplexing (OFDM) system.

In FIG. 1, it is assumed that the wireless communication system includes (M+2) terminals with a single antenna. The wireless communication system may include a single transmitting terminal 101, a single receiving terminal 103, and M relay terminals 102. In this instance, I={1, 2, . . . , M} and i∈I

. I denotes a relay terminal set that includes relay terminals R₁, R₂, . . . , R_{M}. M is greater than or equal to 1. Also, throughout the specification, the transmitting terminal 101 may function as a source terminal S. The receiving terminal 103 may function as a destination terminal D. However, the present invention is not limited to the single transmitting terminal 101 and the single receiving terminal 103.

The present invention will be described herein based on the single transmitting terminal 101 with the M relay terminals 102. This is for description of convenience. In the wireless communication system that performs the cooperative diversity using the cyclic delay, users cooperating with data transmission may obtain the same gain.

According to an aspect of the present invention, it is assumed that transmission power of the wireless communication system is less than or equal to the transmission power of a direction transmission not adopting the present invention. For example, in order to directly transmit data from the transmitting terminal 101 to the receiving terminal 103, the wireless communication system may allocate one half of the total transmission power to the transmitting terminal 101 and also allocate the remaining transmission power to the M relay terminals 102.

Accordingly, when the M relay terminals 102 use one half of the total transmission power required for the direct transmission through cooperation, the total transmission power according to an aspect of the present invention will be the same as the transmission power required for the direct transmission.

In the case of the direct transmission that does not apply a cooperative diversity scheme, each of users may have, as channel resource, an orthogonal time slot consisting of N symbols. In the case of the cooperative diversity scheme using the wireless communication system according to an aspect of the present invention, the transmitting terminal 101 may divide the whole available channels by two orthogonal sub-channels for transmission of the transmitting terminal 101 and relay transmission of the relay terminals 102.

The transmitting terminal 101 may transmit data to each of the M relay terminals 102 and the receiving terminal 103. The transmitting terminal 101 may transmit only one half of the total transmission symbols of the data.

Each of the M relay terminals 102 may detect an error in the data received from the transmitting terminal 101. The relay terminal 102 that detects the error in the data may not cooperate with the data transmission and may feed back an error detection result to the transmitting terminal 101.

Referring to FIG. 1, it may be assumed that the relay terminal R₂ detects the error in the data. In this case, other remaining relay terminals 102 excluding the relay terminal R₂ may cooperate with the data transmission. More specifically, the remaining cooperative relay terminals 102 may transmit, to the receiving terminal 103, the remaining transmission symbols of the data that are not transmitted by the transmitting terminal 101.

Therefore, when the data is transmitted via the cooperative relay terminals 102, it is possible to improve the frequency efficiency and the reliability in comparison to the direct transmission. In FIG. 1, at least one of the M relay terminals 102 may cooperate with the data transmission.

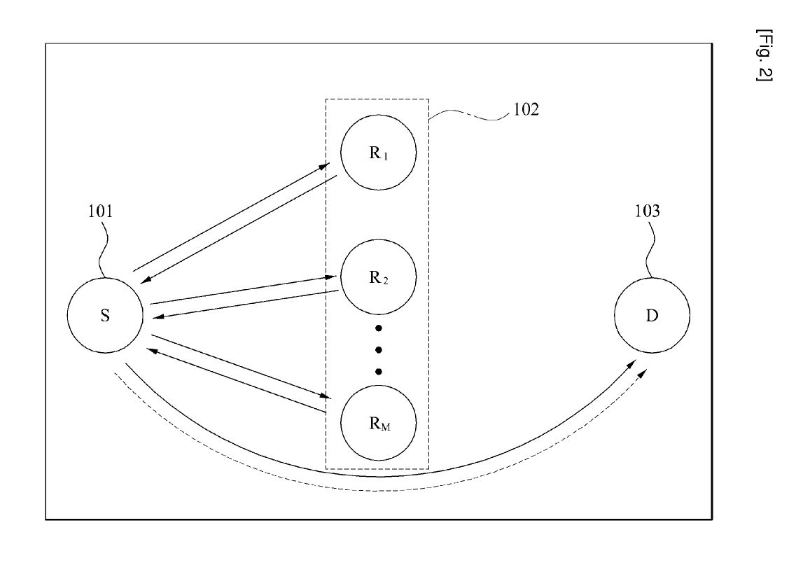

FIG. 2 illustrates an example of transmitting data based on cooperative diversity when each of at least one relay terminal detects an error in data according to an embodiment of the present invention.

A transmitting terminal 101 may transmit data to each of M relay terminals 102, which is the same as FIG. 1. The transmitting terminal 101 may transmit only one half of total transmission symbols of e data.

Each of the M relay terminals 120 may detect an error in the data that is received from the transmitting terminal 101. The relay terminal 102 that detects the error in the data may not cooperate with the data transmission and may feed back an error detection result to the transmitting terminal 101.

In this instance, when each of the M relay terminals 102 detects the error in the received data, all the M relay terminals 102 may not cooperative with the data transmission. Therefore, the transmitting terminal 101 may directly transmit the data to a receiving terminal 103. For example, the transmitting terminal 101 may transmit, to the receiving terminal 103, the remaining transmission symbols of the data that are not transmitted. Therefore, the transmitting terminal 101 may transmit the total transmission symbols of the data.

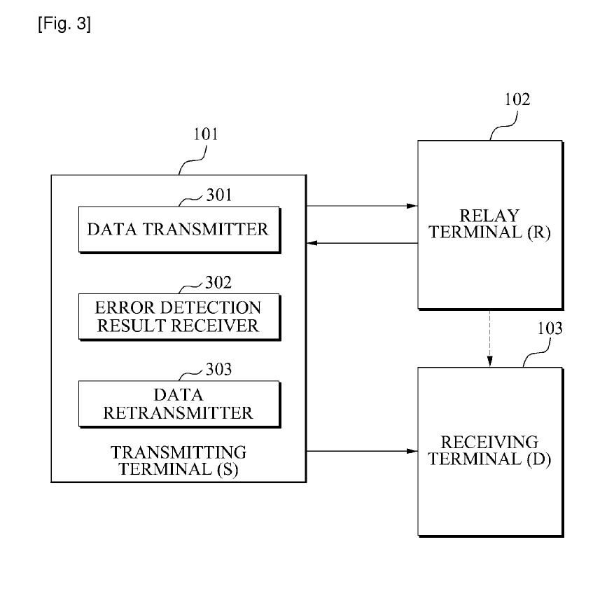

FIG. 3 is a block diagram illustrating a configuration of a transmitting terminal 101 constituting a wireless communication system according to an embodiment of the present invention.

The transmitting terminal 101 includes a data transmitter 301, an error detection result receiver 302, and a data retransmitter 303. Descriptions of FIG. 3 will be made generally based on the assumption that the transmitting terminal 101 and a single relay terminal 102 is provided. The descriptions will be applied to another relay terminal as is.

The data transmitter 301 may transmit data to each of the single relay terminal 102 and the receiving terminal 103.

The data transmitter 301 may add a cyclic prefix (CP), corresponding to a guard interval, to the data and thereby transmit the data. For example, the data transmitter 301 may encode data to be transmitted, through channel decoding. Inverse fast Fourier transform (IFFT) may be performed for transmission symbols of the encoded data. The CP corresponding to the length of the guard interval may be added to the inverse fast Fourier transformed transmission symbols. The transmission symbols with the added CP may be transmitted via a transmitting antenna.

When frequency domain data

(X₀, . . . , X_{N-1})

with length N is modulated via

N

subcarriers, an OFDM transmission symbol of a time domain may be generated by performing inverse discrete Fourier transform (IDFT) for the frequency domain data. The OFDM transmission symbol of the time domain may be represented as,

$$x ( n ) = \frac{1}{\sqrt{N}} {\sum }_{k = 0}^{N - 1} X ( k ) {e}^{j ( 2 π / N ) kn} , \\ n = 0 , 1 , … , N - 1. \qquad [ Equation 1 ]$$

n

denotes a time and

k

denotes a frequency. When adding a CP with length

G

to the symbol, it may be represented as,

\tilde{x}(n+G)_{N+G}=x(n)_{N}, n=0, 1, . . . , N+G−1. [Equation 2]

(n)_{N}

denotes a remainder of modulo

N

with respect to

n

.

For example, the data transmitter 301 may transmit one half of transmission symbols of the data to each of the relay terminal 102 and the receiving terminal 103, for a first sub-channel among sub-channels orthogonal with respect to an allocated channel. Specifically, the data transmitter 301 may perform IFFT for one half of transmission symbols of the encoded data and then add a CP to the inversed fast Fourier transformed transmission symbols of the encoded data and may broadcast the transmission symbols of the encoded data with the added CP to the relay terminal 102 and the receiving terminal 103.

According to an aspect of the present invention, the relay terminal 102 may be one or more. In this case, when the data transmitter 301 transmits data to an i^{th} relay terminal and the receiving terminal 103 for the first sub-channel, received time domain signals may be represented as,

yₛᵢ(n)=hₛᵢ(n) [symbol] x(n)+nₛᵢ(n) [Equation 3]

,

y_{sd}(n)=h_{sd}(n) [symbol] x(n)+n_{sd}(n)

.

[symbol]

denotes a convolution operation,

yₛᵢ(n)

denotes a signal that is transmitted from the transmitting terminal 101 to the i^{th} relay terminal, and

y_{sd}(n)

denotes a signal that is transmitted from the transmitting terminal 101 to the receiving terminal 103.

hₛᵢ(n)

and

h_{sd}(n)

denote fading channel coefficients.

nₛᵢ(n)

and

n_{sd}(n)

denote additive noise. The average of the fading channel coefficients and the additive noise is zero and includes the same distribution as an independent circularly symmetric complex Gaussian random variable with 1 and

N₀

as variance. It is herein assumed that the fading channel coefficient is constant for a single frame and an independent quasi-static fading channel is provided between terminal devices.

A frequency domain signal that the receiving terminal 103 receives from the transmitting terminal 101 for the first sub-channel may be represented as,

Y_{sd}(k)=H_{sd}(k)X(k)+N_{sd}(k) [Equation 4]

.

In this instance, when the frequency domain signal is received via

L_{sd}

multi-paths,

H_{sd}(k)

may be represented as,

$${H}_{sd} ( k ) = \frac{1}{\sqrt{N}} {\sum }_{n = 0}^{{L}_{sd} - 1} {h}_{sd} ( n ) {e}^{- j ( 2 π / N ) kn} . \qquad [ Equation 5 ]$$

With the assumption of frequency flat channel fading in Equation 5,

L_{sd}

=0 and

H_{sd}(k)=h_{sd}(n)/\sqrt{N}

As described above, when performing cooperative diversity according to an aspect of the present invention, the transmitting terminal 101 may divide the total available channels by two orthogonal sub-channels for transmission of the transmitting terminal 101 and the relay transmission of the at least one relay terminal 102.

The error detection result receiver 302 may receive an error detection result from a relay terminal 102 that detects an error in the data among the at least one relay terminal. The error detection result receiver 302 may receive one-bit information from the relay terminal 102 that detects the error via a Cyclic Redundancy Check (CRC), among the at least one relay terminal 102.

When the relay terminal 102 detects the error in the data, the relay terminal 102 may feed back the error detection result to the transmitting terminal 101. Conversely, when the relay terminal 102 does not detect the error in the data, the relay terminal 102 may cooperate with the data transmission and transmit to the receiving terminal 103 the remaining transmission symbols of the data that are not transmitted by the data transmitter 301.

When it is determined each of the at least one relay terminal 102 detects the error in the data based on the error detection result, the data retransmitter 303 may retransmit data to the receiving terminal 103. For example, the data transmitter 303 may retransmit the remaining transmission symbols of the data to the receiving terminal 103 for a second sub-channel among the sub-channels orthogonal with respect to the allocated channel.

Accordingly, when each of the at least one relay terminal 102 does not cooperate with the data transmission at all, the transmitting terminal 101 may transmit, to the receiving terminal 103, all the data to be transmitted.

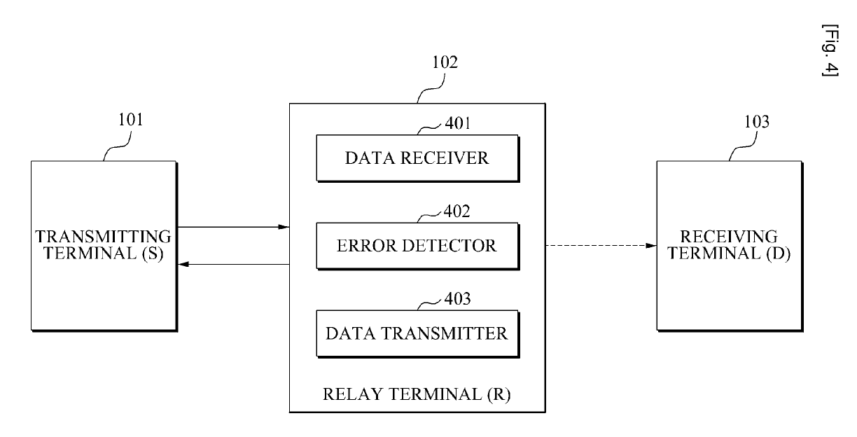

FIG. 4 is a block diagram illustrating a configuration of a relay terminal 102 constituting a wireless communication system according to an embodiment of the present invention.

Referring to FIG. 4, the relay terminal 102 includes a data receiver 401, an error detector 402, and a data transmitter 403. The relay terminal 102 may be one or more.

The data transmitter 401 may receive data from a transmitting terminal 101. Specifically, the data receiver 401 may receive one half of transmission symbols of the data from the transmitting terminal 101 for a first sub-channel among sub-channels orthogonal with respect to a channel allocated to the transmitting terminal 101. The data received from the transmitting terminal 101 may be the same as

yₛᵢ(n)

of Equation 3.

The error detector 402 may detect an error in the received data via a CRC and transmit an error detection result to the transmitting terminal 101. Specifically, the error detector 402 may remove a CP in the received data, decode the received data with the CP removed, and detect the error in the decoded data via the CRC.

For example, the error detector 402 may remove the CP in the data received from the transmitting terminal 101 and then perform fast Fourier transform (FFT). Also, the error detector 402 may decode the fast Fourier transformed data and then detect the error in the decoded data via the CRC. The relay terminal 102 that does not detect the error in the data via the CRC may cooperate with data transmission. Conversely, the relay terminal 102 that detects the error in the data via the CRC may not cooperate with the data transmission.

When all the relay terminals 102 detect the error in the data via the CRC, the relay terminals 102 may not cooperate with the data transmission. In this case, the relay terminals 102 may transmit one-bit information to the transmitting terminal 101.

For a second sub-channel, the transmitting terminal 101 may transmit the remaining transmission symbols of the data that is not transmitted by the transmitting terminal 101 for the first sub-channel. Specifically, the transmitting terminal 101 may transmit the total data to be transmitted, whereas all the relay terminals 102 may not cooperate with the data transmission.

Since a receiving terminal 103 estimates a channel for each sub-channel, there is no change in a decoding algorithm. Also, depending on cooperation of the at least one relay terminal 102, there may be no change in a transmission rate of the transmitting terminal 101 that is received by the receiving terminal 103.

When no error is detected in the data, the data transmitter 403 may transmit, to the receiving terminal 103, data that is cyclic delayed by a number of transmission symbols of the received data. The data transmitter 403 may re-encode the received data, generate the remaining transmission symbols of the data, perform cyclic delay for the generated transmission symbols, and transmit the cyclic delayed transmission symbols. The data transmitter 403 may transmit the generated transmission symbols for a second sub-channel, among sub-channels orthogonal with respect to the channel allocated to the transmitting terminal 101.

Specifically, the data transmitter 403 may perform IFFT for symbols to be transmitted in the same way as the transmitting terminal 101 and then perform cyclic delay by a different number of symbols for each relay terminal 102, add a CP to the symbols, and transmit the symbols with the added CP to the receiving terminal 103. According to an aspect of the present invention, it is possible to maximize the cooperative gain by applying a different cyclic delay for each relay terminal cooperating with data transmission.

When

Q

relay terminals 102 do not detect the error in the data via the CRC, a set of co-operative relay terminals 102 may be represented as

V

. Here, the relationship such as

i∈V

and

V⊂I

may be satisfied. i denotes an n^{th} relay terminal 102 for data transmission and I denotes a total of relay terminals 102. A time domain signal that the receiving terminal 103 receives from each of the

Q

relay terminals 102 may be represented as,

$${y}_{rd} ( n ) = α {\sum }_{i ∈ V} {h}_{i d} ( n ) ⊗ {\hat{x} ( n - {τ}_{i} )}_{N} + {n}_{rd} ( n ) . \qquad [ Equation 6 ]$$

α

denotes a ratio of transmission power of the relay terminal 102 to transmission power of the transmitting terminal 101,

\hat{x}(n)

denotes a signal re-encoded by the relay terminal 102,

τᵢ

denotes cyclic delay with respect to an i^{th} relay terminal 102, and delay interval of

τᵢ

denotes a symbol interval of data

{x(n)}

.

When 1/M folds of the transmission power of the transmitting terminal 101 are allocated to M cooperative relay terminals 102,

α=1/M

. When all of the M transmitting terminals 102 cooperate with the data transmission, the total transmission power according to the present invention may be the same as the total transmission power of the direct transmission at all times.

A frequency domain signal that the receiving terminal 103 receives from the relay terminal each of the at least one relay terminal 102 that cooperates with the data transmission for the second sub-channel may be represented as,

$${Y}_{rd} ( k ) = α {\sum }_{i ∈ V} {H}_{i d} ( k ) {e}^{- j ( 2 π / N ) k {τ}_{i}} \hat{X} ( k ) + {N}_{rd} ( k ) . \qquad [ Equation 7 ]$$

When the frequency domain signal is received via

L_{id}

multi-paths,

H_{id}(k)

may be given by,

$${H}_{i d} ( k ) = \frac{1}{\sqrt{N}} {\sum }_{n = 0}^{{L}_{i d} - 1} {h}_{i d} ( n ) {e}^{- j ( 2 π / N ) kn} . \qquad [ Equation 8 ]$$

An effective channel of the frequency domain received by the receiving terminal 103 may be represented as,

$$\begin{matrix}{H}_{r d} ( k ) = \frac{1}{\sqrt{N}} {\sum }_{i ∈ V} ( {\sum }_{n = 0}^{{L}_{i d} - 1} {h}_{i d} ( n ) {e}^{- j ( 2 π / N ) kn} ) {e}^{- j ( 2 π / N ) k {τ}_{i}} \\ = \frac{1}{\sqrt{N}} {\sum }_{i ∈ V} {\sum }_{n = 0}^{{L}_{i d} - 1} {h}_{i d} ( n ) {e}^{- j ( 2 π / N ) k ( n + {τ}_{i} )} .\end{matrix} \qquad [ Equation 9 ]$$

A signal that the receiving terminal 103 receives from each of the at least one relay terminal 102 for the second sub-channel may be represented as,

Y_{rd}(k)=H_{rd}(k)\hat{X}(k)+N_{rd}(k) [Equation 10]

.

Accordingly, one half of total transmission symbols of data may be transmitted from the transmitting terminal 101 to the receiving terminal 103. The transmission symbols of the data that are not transmitted by the transmitting terminal 101 may be generated by the at least one cooperative relay terminal 102 and be transmitted to the receiving terminal 103. Consequently, the receiving terminal 103 may receive the total transmission symbols of the data of the transmitting terminal 101 from the transmitting terminal 101 and the cooperative relay terminals 102.

The receiving terminal 103 may receive the total encoded symbols like Equation 4 and Equation 10, from the receiving terminal 103 and the at least one relay terminal 102 that cooperates with the data transmission. The receiving terminal 103 may de-multiplex the received symbols, decode the de-multiplexed symbols, and then estimate the total data.

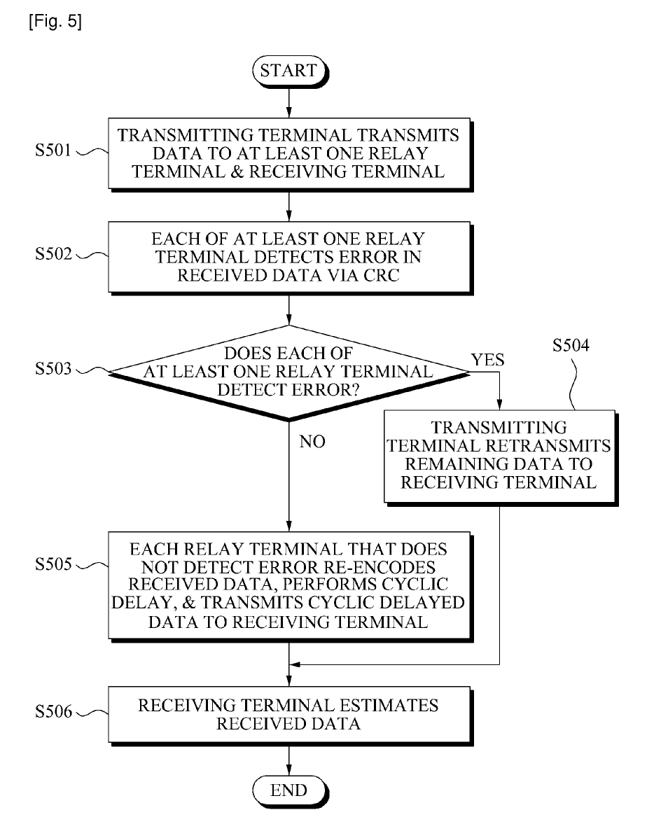

FIG. 5 is a flowchart illustrating a method of transmitting data based on cooperative diversity using cyclic delay according to an embodiment of the present invention.

In a cooperative diversity method according to an aspect of the present invention, a transmitting terminal may transmit a portion of data to at least one relay terminal and a receiving terminal in operation S501.

Specifically, in operation S501, the transmitting terminal may transmit one half of transmission symbols of the data to the at least one relay terminal and the receiving terminal, for a first sub-channel among sub-channels orthogonal with respect to an allocated channel.

In operation S502, each of the at least one relay terminal may detect an error in the received data via a CRC.

Each of the at least one relay terminal that receives the data from the transmitting terminal in operation S501 may remove a CP in the received data, decode the data with the CP removed, and detect the data in the decoded data via the CRC.

In operation S503, it may be determined whether each of the at least one relay terminal detects the error in the data.

Depending on the determination result, it may be determined whether each of the at least one relay terminal cooperates with transmitting of the remaining data. When the error is detected, each of the at least one relay terminal may not cooperate with the data transmission and may transmit an error detection result to the receiving terminal.

In operation S504, when each of the at least one relay terminal detects the error in the data, the receiving terminal may retransmit the remaining transmission symbols of the data to the receiving terminal. According to an aspect of the present invention, the transmitting terminal may retransmit the remaining transmission symbols of data for a second sub-channel among sub-channels orthogonal with respect to an allocated channel.

When a portion of the at least one relay terminal detects the error in the data, each relay terminal that does not detect the error may cooperate with the data transmission. Specifically, when the error is not detected in the data, the corresponding each relay terminal may re-encode the received data, generate the remaining transmission symbols of the data, perform cyclic delay for the generated transmission symbols, and transmit the cyclic delayed transmission symbols in operation S505. In this instance, a level of cyclic delay of the transmission symbols may be different for each relay terminal.

The relay terminal cooperating with the data transmission may transmit the generated transmission symbols to the receiving terminal for a second sub-channel, among sub-channels orthogonal with respect to a channel allocated to the transmitting terminal.

In operation S506, the receiving terminal may estimate the data received from the receiving terminal or the cooperative relay terminal.

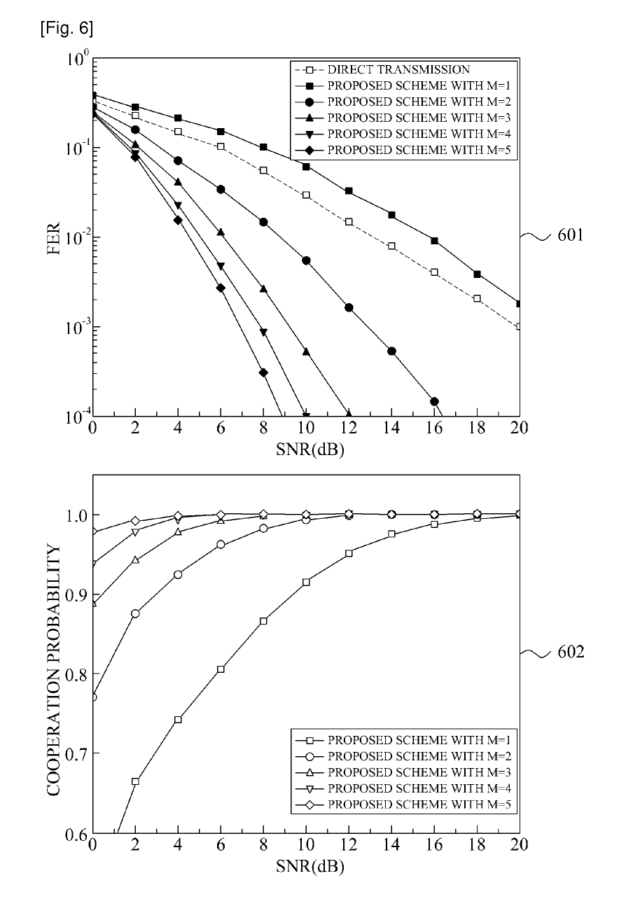

FIGS. 6 through 8 are graphs illustrating simulation test results after performing cooperative diversity in a wireless communication system according to an embodiment of the present invention.

FIG. 6 illustrates graphs of a frame error rate and a cooperation probability based on a number of relay terminals constituting a wireless communication system according to an embodiment of the present invention.

In FIG. 6, it is assumed that the wireless communication system uses binary phase shift keying (BPSK) and convolutional codes 53, 67, 71, and 75 with a constraint length K=6 and a code rate of 1/4. However, the present invention is not limited thereto.

For a first sub-channel, a transmitting terminal may use the convolutional codes 53 and 75 that are known as optimal among the above convolutional codes with the code rate of 1/4 and the constraint length K=6. For a second sub-channel, relay terminals that cooperate with the data transmission may use the convolutional codes 67 and 71.

Here, it is assumed that the wireless communication system uses the frame size of 256 bits and an ideal CRC code. Also, it is assumed that a channel model according to the wireless communication system has a signal-to-noise ratio (SNR) of 0 dB, −5 dB, and −10 dB, and uses 3-ray Rayleight fading with a multi-path that is delayed from an initially received signal by each symbol. Specifically,

L_{sd}=Lₛᵢ=L_{id}

, and

i∈V

. When

i∈V

, cyclic delay to satisfy

τᵢ≧L_{id}i

may be applied to the cooperative relay terminals.

A graph 601 shows a frame error rate based on a number of cooperative relay terminals when applying the cooperative diversity using the cyclic delay by encoding data to the convolutional codes 53, 67, 71, and 75. Here, it is assumed that

α=1/M

. Referring to the graph 601, except for when only a single relay terminal is cooperative, when the present invention is applied, the frame error rate was improved in comparison to the existing wireless communication system. Also, the diversity gain was improved based on the number of cooperative relay terminals.

For example, when comparing a case where five relay terminals are cooperative with the existing relay wireless communication system, it can be seen that performance gain of 4.5 dB was provided for the frame error of 10⁻¹. Performance gain of 8.5 dB was provided for the frame rate of 10⁻². Also, performance gain of 13.1 dB was provided for the frame error of 10⁻³.

A graph 602 shows a cooperation probability based on the number of cooperative relay terminals when transmitting the data encoded to the convolutional codes 53, 67, 71, and 75 based on the cooperative diversity using the cyclic delay. Here, it is assumed that

α=1/M

. In the data transmission according to an aspect of the present invention, the cooperation probability may denote a probability that at least one relay terminal may cooperate with the data transmission.

Referring to the graph 602, as the number of cooperative relay terminals increases, the cooperation probability also increases. Specifically, as the number of cooperative relay terminals increases, the cooperation probability of the at least one relay terminal may approach 1 in a lower SNR.

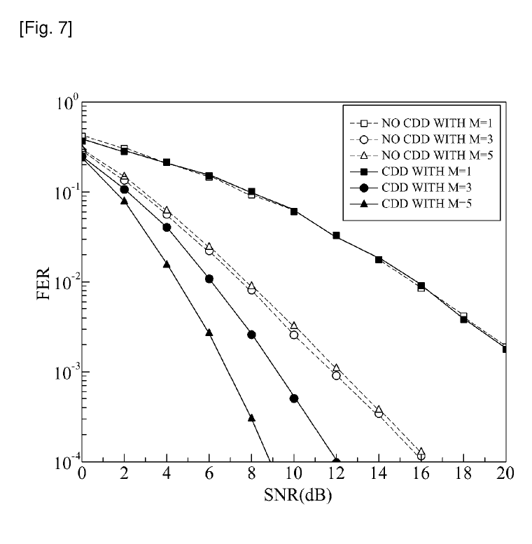

FIG. 7 is a graph illustrating a frame error rate of each of when cyclic delay is used and when the cyclic delay is not used in a wireless communication system according to an embodiment of the present invention.

In a cooperative diversity scheme that transmits data encoded to convolutional codes 53, 67, 71, and 75, the graph of FIG. 7 shows the frame error rate of when the cooperative diversity scheme uses the cyclic delay and of when the cooperative diversity scheme does not use the cyclic delay. Here, it is assumed that

α=1/M

. Referring to the graph, it can be seen that the frame error rate when applying the cyclic delay was significantly improved in comparison to the frame error rate when not applying the cyclic delay.

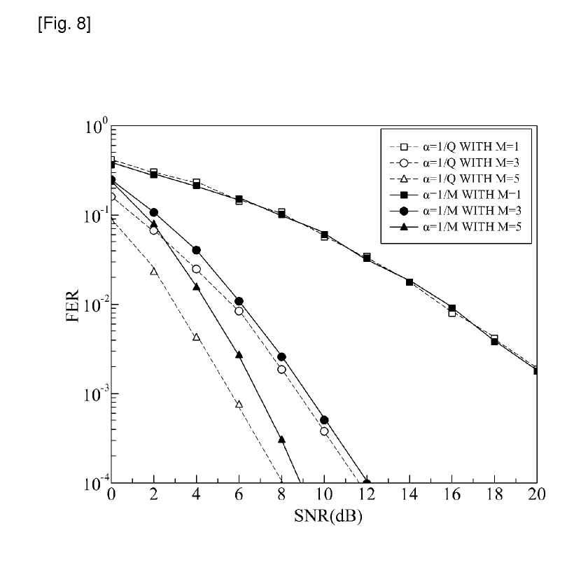

FIG. 8 is a graph illustrating a frame error rate based on a transmission power allocation of a relay terminal in a wireless communication system according to an embodiment of the present invention.

The graph of FIG. 8 shows the frame error rate based on allocation of transmission power of the relay terminal when transmitting data encoded to convolutional codes 53, 67, 71, and 75 based on the cooperative diversity using the cyclic delay. Referring to the graph, the frame error rate of when

α=1/Q

was more improved than the frame error rate when

α=1/M

. Also, as the number of cooperative relay terminals increase, the difference between the frame error rates increases.

According to the present invention, there is provided a wireless communication system and method that can perform cooperative diversity using cyclic delay.

Also, according to the present invention, there is provided a cooperative diversity method that can provide improved diversity gain according to a cooperative relay terminal with an improved performance in comparison to an existing wireless communication system.

Also, according to the present invention, there is provided a cooperative diversity method that can improve the efficiency of the bandwidth since at least one relay terminal cooperating with data transmission can simultaneously retransmit data received from a transmitting terminal for the same sub-channel.

Also, according to the present invention, there is provided a cooperative diversity method that can apply a different cyclic delay to each relay terminal and thereby can maximize diversity gain.

Also, according to the present invention, there is provided a cooperative diversity method that can allocate a normalized transmission power based on a number of relay terminals substantially cooperating with data transmission and thereby maximize diversity gain.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

1. A transmitting terminal comprising:
a data transmitter configured to transmit data to each of at least one relay terminal and a receiving terminal;
an error detection result receiver to receive an error detection result from a relay terminal that detects an error in the data among the at least one relay terminal; and
a data retransmitter configured to retransmit data to the receiving terminal when it is determined each of the at least one relay terminal detects the error in the data based on the error detection result.

2. The transmitting terminal of claim 1, wherein the data transmitter is configured to add a cyclic prefix, corresponding to a guard interval, to the data and thereby transmit the data.

3. The transmitting terminal of claim 1, wherein the data transmitter is configured to transmit one half of transmission symbols of the data to each of the at least one relay terminal and the receiving terminal, for a first sub-channel among sub-channels orthogonal with respect to an allocated channel.

4. The transmitting terminal of claim 3, wherein the data retransmitter is configured to retransmit the remaining transmission symbols of the data to the receiving terminal for a second sub-channel among the sub-channels orthogonal with respect to the allocated channel.

5. A relay terminal comprising:
a data receiver configured to receive data from a transmitting terminal;
an error detector configured to detect, via a Cyclic Redundancy Check (CRC), an error in the received data and transmit an error detection result to the transmitting terminal; and
a data transmitter configured to transmit, to a receiving terminal, data that is cyclic delayed by a number of transmission symbols of the received data, when no error is detected in the data.

6. The relay terminal of claim 5, wherein the data receiver is configured to receive one half of transmission symbols of the data from the transmitting terminal for a first sub-channel among sub-channels orthogonal with respect to a channel allocated to the transmitting terminal.

7. The relay terminal of claim 6, wherein the data transmitter is configured to generate the remaining transmission symbols, perform cyclic delay for the generated transmission symbols, and transmit the cyclic delayed transmission symbols.

8. The relay terminal of claim 7, wherein the data transmitter is configured to transmit the generated transmission symbols for a second sub-channel among sub-channels orthogonal with respect to the channel allocated to the transmitting terminal.

9. A cooperative diversity method comprising:
transmitting data to each of at least one relay terminal and a receiving terminal; and
receiving an error detection result from a relay terminal that detects an error in the data among the at least one relay terminal.

10. The cooperative diversity method of claim 9, further comprising:
retransmitting data to the receiving terminal when it is determined each of the at least one relay terminal detects the error in the data based on the error detection result.

11. The cooperative diversity method of claim 9, wherein the transmitting comprises transmitting one half of transmission symbols of the data to each of the at least one relay terminal and the receiving terminal, for a first sub-channel among sub-channels orthogonal with respect to an allocated channel.

12. The cooperative diversity method of claim 10, wherein the retransmitting comprises retransmitting the remaining transmission symbols of the data to the receiving terminal for a second sub-channel among the sub-channels orthogonal with respect to the allocated channel.

13. A cooperative diversity method comprising:
receiving data from a transmitting terminal;
detecting, via a CRC, an error in the received data; and
determining whether to cooperate with transmitting of the data depending on whether the error is detected in the data.

14. The cooperative diversity method of claim 13, wherein the receiving comprises receiving one half of transmission symbols of the data from the transmitting terminal for a first sub-channel among sub-channels orthogonal with respect to a channel allocated to the transmitting terminal.

15. The cooperative diversity method of claim 13, further comprising:
transmitting an error detection result to the transmitting terminal, when the error is detected in the data; and
transmitting, to the receiving terminal, data that is cyclic delayed by a number of transmission symbols of the received data, when no error is detected in the data.

16. The cooperative diversity method of claim 15, wherein the transmitting of the cyclic delayed data comprises:
re-encoding the received data to generate the remaining transmission symbols of the data; and
performing cyclic delay for the generated transmission symbols to transmit the cyclic delayed transmission symbols to the receiving terminal.

17. The cooperative diversity method of claim 15, wherein the transmitting of the cyclic delayed data comprises transmitting the generated transmission symbols for a second sub-channel among sub-channels orthogonal with respect to the channel allocated to the transmitting terminal.
